(19) United States
(12) Patent Application Publication
(10) Pub. No.: US 2014/0207962 A1
(43) Pub. Date: Jul. 24, 2014

(54) Aggregation of User Activity Data Into a User Activity Stream

(71) Applicant: DISNEY ENTERPRISES, INC., Burbank, CA (US)

(72) Inventor: Steven Makofsky, Sammamish, WA (US)

(73) Assignee: Disney Enterprises, Inc., Burbank, CA (US)

(21) Appl. No.: 13/746,245

(22) Filed: Jan. 21, 2013

(51) Int. Cl. H04L 29/06

(52) U.S. Cl. CPC H04L 65/60
USPC 709/231

(57) ABSTRACT

There is provided a system and method for aggregation of user activity data into a user activity stream. The method comprises receiving virtual activity data from a device, receiving real activity data from at least one sensor of the device, aggregating the virtual activity data and the real activity data in the user activity stream, and storing the user activity stream for analysis of user trends. The user trends may be used to customize a digital item, such as a virtual environment, an interactive game, or a social media profile. Additionally, the user trends may be used to deliver personalized content to a user, such as advertisements, user activity options, or interactive digital content. The user activity stream may also be connected to at least one other user profile and may be published for viewing.

### BACKGROUND

People engage in a broad range of daily activities and wish to share their experiences with friends and family. Current devices enable users to send messages, share their status, and post on social media websites, among other features. These devices may come equipped with a broad range of sensors that allow for the collection of data a user may wish to upload. People may use their mobile computing devices while travelling for uploading content, or may broadcast aspects of their daily lives from home, school, and other locations using various computing devices, such as personal computers. Additionally, current technology allows for overlap between social media sites, media content providers, and other interactive websites. Thus, users are able to access their preferred sharing site and upload activities from other sources.

However, users are required to actively engage in this sharing-type behavior. Social media websites and other user generated content sites require an active user who both remembers to post and also has the time and ability to upload content. Thus, users who are performing certain activities, such as bike riding, driving, or other engaging actions, cannot post a status or upload content. Additionally, users may be engrossed in their experience and not want to go through the hassle of managing their online life. At other times, users may simply forget. Unfortunately, this means that friends and family are not always privy to the activities of their loved ones. Moreover, content producers may be unable to provide targeted content at the most opportune times.

### SUMMARY

The present disclosure is directed to aggregation of user activity data into a user activity stream, substantially as shown in and/or described in connection with at least one of the figures, as set forth more completely in the claims.

### BRIEF DESCRIPTION OF THE DRAWINGS

FIG. 1 presents an exemplary diagram of a system for aggregation of user activity data into a user activity stream;

FIG. 2A shows a user device for detecting and transmitting virtual activity data and real activity data;

FIG. 2B shows an aggregation server for receiving virtual activity data and real activity data and creating a user activity stream;

FIG. 3 presents an exemplary system with an aggregation server showing a sample user activity stream;

FIG. 4 shows an exemplary diagram of a more detailed user activity stream; and

FIG. 5 presents an exemplary flowchart illustrating a method for aggregation of user activity data into a user activity stream.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

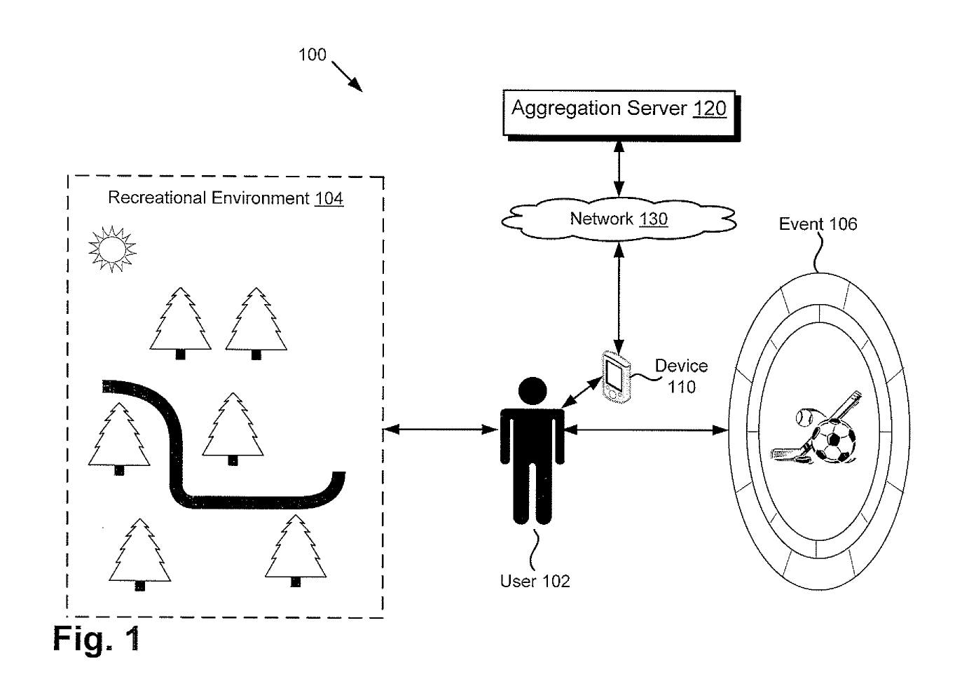

FIG. 1 presents an exemplary diagram of a system for aggregation of user activity data into a user activity stream. System environment 100 of FIG. 1 shows user 102 engaging in daily activities such as hiking in recreational environment 104 and attending event 106. Additionally, user 102 carries device 110 while at recreational environment 104 and event 106. Device 110 is also connected to aggregation server 120 over network 130.

According to FIG. 1, user 102 engages in daily activities such as hiking in recreational environment 104 and attending event 106. User 102 may perform these activities during the normal course of a day. For example, user 102 may wake up on a Saturday and hike through recreational environment 104. Later that night, user 102 may attend a sporting event at event 106. While performing these activities, user 102 brings device 110 and/or utilizes device 110 in conjunction with the activity. For example, user 102 may bring device 110 while hiking in recreational environment 104 to listen to music or to text friends and ask them to join user 102. Similarly, user 102 may bring device 110 with user 102 to event 106 and utilize device 110 to stay in contact with friends, look up additional sports scores, or other function of device 110.

Additionally, while at recreation environment 104 or event 106, device 110 may collect activity data. Device 110 may include device sensors capable of detecting and collecting real activity data. The device sensors may correspond to data collecting sensors, such as a microphone or other audio unit, location detecting sensor, receiver and/or transmitter, or other active device sensor that a user activates. The device sensors may also correspond to more passive data collecting units. Device 110 may actively or passively monitor the device sensors in order to collect activity data. For example, in one implementation, device 110 may actively require input to determine a user location for the activity data. However, in another implementation, device 110 may passively monitor the device sensors, either continuously or at intervals, to determine the user location for the activity data.

Additionally, device 110 may collect virtual activity data while user 102 utilizes device 110 during daily activities. For example, device 110 may contain content, such as music playlists, text messages, viewed, accessed, and/or stored media content, or other content. Device 110 may also store additional data, such as social media interactions and interactive games and which user 102 utilizes. Thus, device 110 may receive virtual activity data, such as high scores, progressions, or changes within an interactive game. User 102 may also microblog or perform other virtual activities.

As further shown in FIG. 1, device 110 is connected to aggregation server 120 over network 130. Aggregation server 120 may correspond to a server for uploading, storing, and aggregating activity data obtained from device 110. Activity data may include real activity data and/or virtual activity data corresponding to user 102. Thus, as will be explained in greater detail later, aggregation server 120 may contain memory databases for storage of activity data, as well as processors for aggregation and/or processing of activity data. While aggregation server 120 is shown as one server, it is understood that aggregation server 120 may correspond to one server or a plurality of servers.

Network 130 may correspond to a network connection, such as a wireless phone service communication network, broadband network, or other network capable of sending of receiving data. Although in the implementation of FIG. 1, device 110 is shown as a personal mobile device, device 110 may be any suitable user computing device, such as a mobile phone, a personal computer (PC) or other home computer, a personal digital assistant (PDA), a television receiver, or a gaming console, for example.

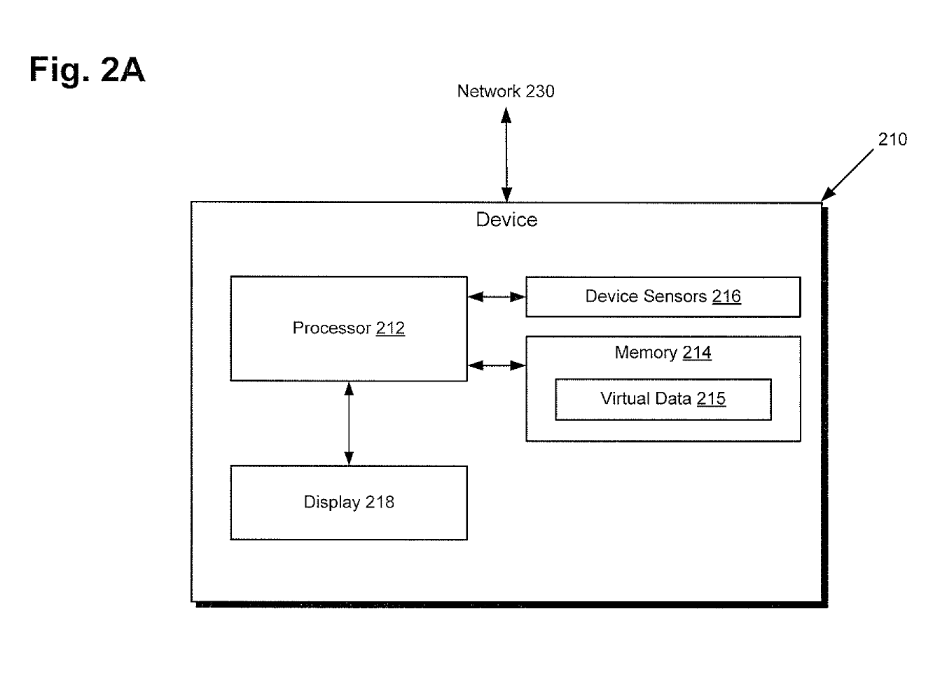

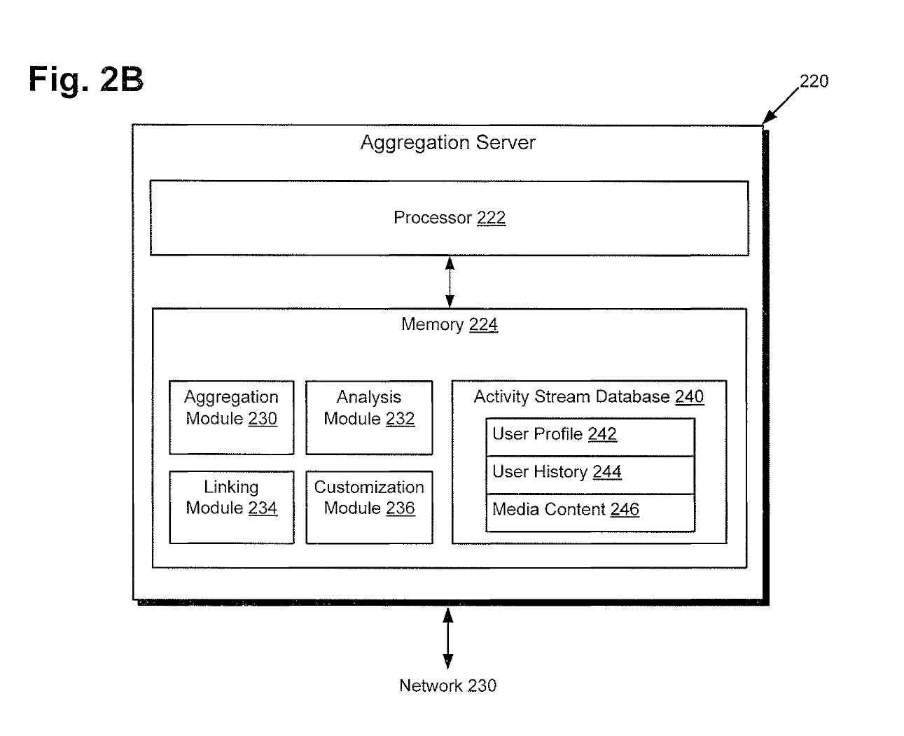

Moving to FIG. 2A, FIG. 2A shows a user device for detecting and transmitting virtual activity data and real activity data. According to FIG. 2A, device 210 contains processor 212 and memory 214 containing virtual data 215. Further shown in device 210 of FIG. 2A are device sensors 216 and display 218. Device 210 is additionally shown connected to network 230. While device 210 is shown as a single device, in other implementations, device 210 may correspond to a plurality of devices networked and/or in communication.

As shown in FIG. 2A, device 210 contains processor 212 and memory 214 containing virtual data 215. Processor 212 of FIG. 2A is configured to access memory 214 to store received input and/or to execute commands, processes, or programs stored in memory 214. For example, processor 212 may receive activity data and store the information in memory 214. Processor 212 may also access memory 214 and utilize and/or transmit virtual data 215. Processor 212 may correspond to a processing device, such as a microprocessor or similar hardware processing device, or a plurality of hardware devices. However, in other implementations, processor 212 refers to a general processor capable of performing the functions required by device 210. Memory 214 is a sufficient memory capable of storing commands, processes, and programs for execution by processor 212. Memory 214 may be instituted as ROM, RAM, flash memory, or any sufficient memory capable of storing a set of commands. In other implementations, memory 214 may correspond to a plurality memory types or modules. Thus, processor 212 and memory 214 contains sufficient memory and processing units to a necessary for device 210. Although memory 214 is shown as located on device 210, in other implementations, memory 214 may be separate but connectable to device 210.

Device 210 of FIG. 2A further includes device sensors 216 in connection with processor 212. As previously discussed, device sensors 216 may include sensors capable of detecting real activity data corresponding to a user and transmitting the data to processor 212. Device sensors 216 may include a GPS sensor, camera, motion sensor, data transmission unit, audio unit, compass, and/or additional device sensors. Although device sensors 216 are shown as embedded in or part of device 210, in other implementations device sensors 216 may be detached but connectable to device 210. Device sensors 216 may correspond to one device sensor or a plurality of device sensors.

Device sensors 216 may actively collect user activity data, such as through permissions, requests, and/or active user activation and input into device sensors 216. Additionally, device sensors 216 may passively collect user activity data, such as through monitoring and/or collecting user activity data without user activation or entry. For example, processor 212 may be instructed to determine a user location using a GPS sensor of device sensors 216, may consistently monitor the GPS sensor, or may sample the GPS sensor at discreet intervals. In another implementation, processor 212 may access a camera to view a surrounding environment or may receive information from the camera when the user utilizes the camera. Thus, processor 212 may receive activity data indicating the user's location or pattern of movement. By monitoring device sensors 216, processor 212 of device 210 may receive activity data from user commands or may passively monitor device sensors 216 and collect activity data without user action.

Processor 212 may receive activity data from device sensors 216 and save the activity data in memory 214. For example, processor 212 may receive pictures taken from a camera of device sensors 216, may receive location information, such as a list of visited locations, from a GPS sensors, and/or may receive other activity data from device sensors 216.

Processor 212 may also receive virtual activity data corresponding to a user from virtual data 215 in memory 214. For example, the user may utilize a music library to play a set of songs. Processor 212 may receive the playlist or may even view the music library and see most played songs, favorite songs, or favorite music genres. Virtual data 215 may also include an interactive game accessible by processor 212 of device 210. While playing the interactive game, a user may access content, enter information, or otherwise provide virtual activity data.

Device 210 is further connected to network 230 in order to transmit and receive data. As previously discussed, network 230 may be any form of network connection for communication of data. Thus, network 230 allows device 210 to transmit activity data. For example, device 210 may transmit real activity data taken from device sensors 216 over network 230. Additionally, device 210 may access virtual data 215 on memory 214 to transmit virtual activity data corresponding to virtual data 215. Additionally, device 210 may utilize network communication 230 with activity data, such as by utilizing network 230 in conjunction with a GPS sensor of device sensors 216 to determine location information.

Device 210 contains display 218 connected to processor 212. Display 218 may correspond to a visual display unit capable of presenting and rendering media content for a user. Display 218 may correspond to a liquid crystal display, plasma display panel, cathode ray tube, or other display. Processor 212 is configured to access display 218 in order to render content for viewing by the user. While FIG. 2 shows display 218 as part of device 210, in other implementations, display 218 may be external to device 210 or separate and connectable to device 210. Thus, in certain implementations, such as when device 210 is a television receiver, display 218 may be separate and connectable to device 210. Additionally, display 218 may correspond to one visual display unit or a plurality of visual display units.

As shown in FIG. 2B, FIG. 2B shows an aggregation server for receiving virtual activity data and real activity data and creating a user activity stream. FIG. 2B shows aggregation server 220 with processor 222 and memory 224 containing aggregation module 230, analysis module 232, linking module 234, and customization module 236. Additionally shown on memory 224 of FIG. 2B is activity stream database 240 having user profile 242, user history 244, and media content 246. Aggregation server 220 is further shown accessible over network 230. Although aggregation server 220 is shown as a single server, in other implementations, aggregation server 220 may correspond to a plurality of servers networked and/or in communication.

As previously discussed, network 230 may be any form of network connection for communication of data. Thus, network 230 allows aggregation server 220 to transmit and receive activity data. For example, aggregation server 220 may receive real activity data taken from a device containing device sensors over network 230. Additionally, device 210 may receive virtual activity data over network 230. Additionally, aggregation server 220 may receive activity data from another source, such as one or more additional aggregation servers.

Aggregation server 220 of FIG. 2B contains processor 222 and memory 224 containing aggregation module 230, analysis module 232, linking module 234, customization module 236, and activity stream database 240. Processor 222 of FIG. 2B is configured to access memory 224 to store received input and/or to execute commands, processes, or programs stored in memory 224, such as aggregation module 230, analysis module 232, linking module 234, customization module 236, and/or activity stream database 240. Processor 222 may also receive activity data and utilize the activity data with one of modules 230, 232, 234, and/or 236. Processor 222 may correspond to a processing device, such as a microprocessor or similar hardware processing device, or a plurality of hardware devices. However, in other implementations, processor 222 refers to a general processor capable of performing the functions required by aggregation server 220. Memory 224 is a sufficient memory capable of storing data, commands, processes, and programs for execution by processor 222. Memory 224 may be instituted as ROM, RAM, flash memory, or any sufficient memory capable of storing a set of commands. In other implementations, memory 224 may correspond to a plurality memory types or modules. Thus, any or all of aggregation module 230, analysis module 232, linking module 234, customization module 236, and/or activity stream database 240 may be located on separate memory modules or databases. Processor 222 and memory 224 contains sufficient memory and processing units to a necessary for aggregation server 220. Although memory 224 is shown as located on aggregation server 220, in other implementations, memory 224 may be separate but connectable to aggregation server 220.

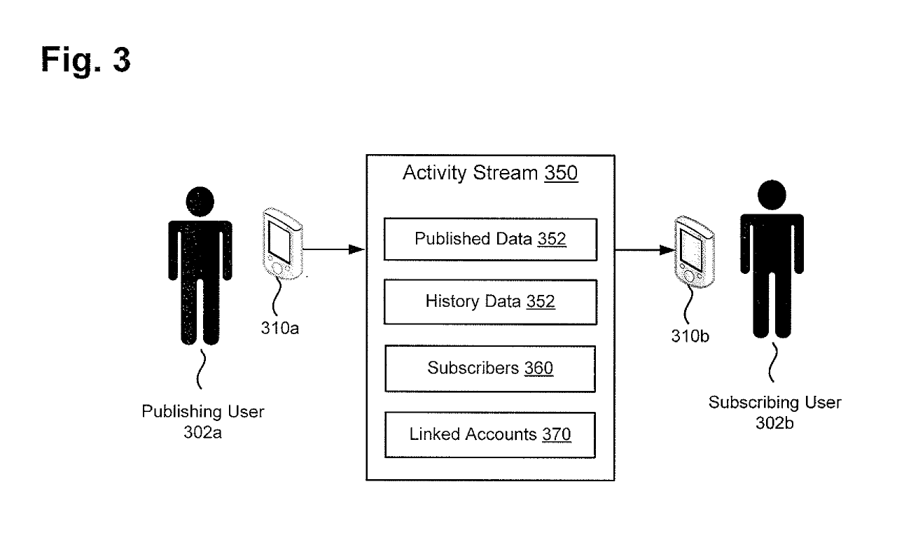

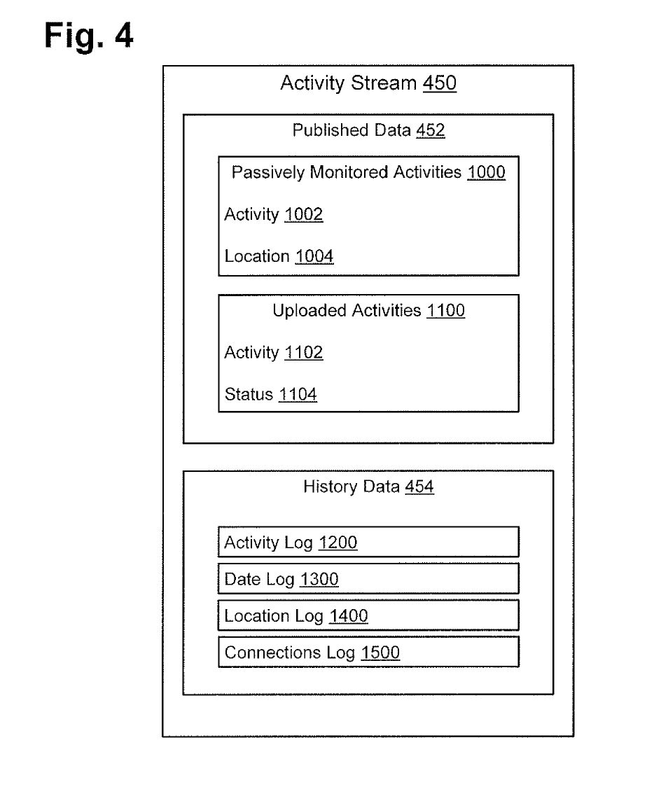

Memory 224 of FIG. 2B contains aggregation module 230, analysis module 232, linking module 234, and customization module 236. Modules 230/232/234/236 may correspond to programs, processes, and/or applications executable by processor 222. Each module 230/232/234/236 may include a processing application for user with user activity data. For example, aggregation server 220 may receive activity data, such as from a device. Processor 222 of aggregation server 220 may access memory 224 to initiate aggregation module 230 stored in memory 224. Aggregation module 230 may include processes to aggregate, organize, or otherwise collect real and virtual activity data corresponding to a user. Thus, aggregation module 230 may identify activity data as corresponding to a specific user and aggregate the activity data into a timeline. As will be discussed further in reference to FIGS. 3 and 4, aggregation module 230 may sort activity data by date, location, topic, or other factor. Aggregation module 230 may further include processes for aggregating and creating a user activity stream based on the activity data.

Additionally, memory 224 of aggregation server 220 may include analysis module 232. Analysis module 232 may include processes for analysis of real and virtual activity data corresponding to a user. For example, analysis module 232 may include processes to analyze a user activity stream created from aggregation module 230 for user trends. Analysis module 232 may include processes to determine user interests, likes, dislikes, or other user interests. Thus, analysis module 232 may determine if a user frequents a location, type of location, or other user trend. Analysis module 232 may make user trends available for targeted media content, such as targeted advertising, activity options, or interactive digital content. In certain implementations, analysis module 232 may analyze real activity data, such as user locations and/or movements. Thus, as will be discussed further below, analysis module 232 may make such user trends available for personalized content based on the user locations and/or movements. Analysis module 232 may also make user trends available of use and collection by outside processes. For example, user movement trends may be determined using user activity streams. Thus, traffic may be diverted from particular areas of high user concentrations and/or movements.

Memory 224 of FIG. 2B further includes linking module 234. Linking module 234 may include processes to search and match the same or similar user activity streams, real and/or virtual activity data, and/or user trends. Linking module 234 may search for user activity streams locally or using network 230. Linking module 234 may then determine overlaps, receive additional data, or transmit activity data to the same or similar activity streams. Thus, linking module 234 may retrieve additional data to be added to a user activity stream, or distribute received data to other user activity streams as necessary. For example, linking module 234 may search and find a social media profile of the same user as a user activity stream. Linking module 234 may then transmit or receive information to and from the social media profile corresponding to the same user as the user activity stream.

Memory 224 of FIG. 2B further includes customization module 236. Customization module 236 may contain processes to customize content according to a user activity stream or analyzed user trends based on the user activity stream. For example, a user activity stream may determine that a user is located near a specific ride in an amusement park. Using this data, personalized messages, content, or other data may be transmitted to the user or otherwise made available.

Memory 224 of aggregation server 220 in FIG. 2B is also shown with activity stream database 240 having user profile 242, user history 244, and media content 246. Activity stream database 240 may store activity data received by aggregation server 220. Activity stream database 240 may also store user activity streams, user trends, or other relevant user information. Thus, activity stream database 240 may contain information received by aggregation server 220 and processed using modules 230/232/234/236.

Activity stream database 240 contains user profile 242. User profile 242 may correspond to user information, such as a collection of identifying information corresponding to a specific user. For example, user profile 242 may contain name, age, location, or other identifying information. User profile 242 may be configurable by a user or may be separately set up by aggregation server based on received activity data. Activity stream database 240 also contains user history 244. User history 244 may correspond to past activity data, such as previously travelled locations, high scores in interactive games, or other activity data. Activity stream database 240 also contains media content 246. Media content 246 may correspond to saved, uploaded, and stored media content, such as pictures, videos, or other media content.

Moving to FIG. 3, FIG. 3 presents an exemplary system with an aggregation server showing a sample user activity stream. FIG. 3 shows publishing user 302a utilizing device 310a to publish activity data to activity stream 350. Additionally shown in FIG. 3 is subscribing user 302b utilizing device 310b to view activity stream 350. Activity stream 350 is shown with publish data 352, history data 354, subscribers 360, and linked accounts 370.

According to FIG. 3, publishing user 302a utilizes device 310a to transmit activity information to activity stream 350. As previously discussed, user 302a may utilize device 310a to transmit real and/or virtual activity data to activity stream 350. For example, user 302a may utilize a device sensor, such as a camera or a GPS, to obtain real activity data. In another implementation, user 302a may message, play an interactive game, or set a music playlist, to create virtual activity data. As previously discussed, user 302a may actively transmit the real and/or virtual activity data using device 310a. However, in other implementations, device 310a may passively monitor device 310a to obtain and transmit the real and/or virtual activity data, such as without user input. While device 310b is shown as a handheld or mobile device, in other implementations subscribing user 302b may utilizing other computing devices, such as a computer, smart television, or other device to transmit activity data.

The real and/or virtual activity data may then be transmitted to an aggregation server as previously discussed. The aggregation server may utilize modules to perform processes on the real and/or virtual activity data in order to publish activity stream 350. Activity stream 350 contains published data 352, history data 354, subscribers 360, and linked accounts 370. Published data 352 may include published activity data. Published activity data may correspond to real and/or virtual activity data published in activity stream 350, such as visited locations, pictures, high scores, or played media content. Published data 352 may include filters or permissions set by either or both of publishing user 302a and/or the aggregation server.

Activity stream 350 may further contain history data 354. History data 354 may contain past activity data corresponding to a user, such that activity stream 350 provides a timeline of user activities. History data 354 may be archived and may provide past activity data for user by an aggregation server in analyzing user trends and/or delivering personalized content to a user. History data 354 may further have filters and/or permissions configurable by either or both of the user and the aggregation server.

Activity stream 350 also includes subscribers 360 and linked accounts 370. Subscribers 360 may include other user given permission to view activity stream 350. In alternative implementations, subscribers 360 may correspond to a set of other users configured to receive updates from activity stream 350. Additionally, linked account 370 may correspond to user accounts linked to activity stream 350. For example, publishing user 302a may link other accounts of publishing user 302a to activity stream 350. Thus, real and/or virtual activity data published to activity stream 350 may be transmitted to the other accounts. Activity stream 350 may also receive real and/or virtual activity data from the other accounts for use with activity stream 350. In other implementations, publishing user 302a is not required to link the other accounts to activity stream 350 and instead an aggregation server may link activity stream 350 to the other accounts with or without user input.

Finally, as shown in FIG. 3, subscribing user 302b is shown utilizing device 310 to view activity stream 350. Subscribing user 302b may correspond to one of the allowed users designated in subscribers 360 to view, comment, and/or share activity stream 350. Subscribing user 302b is shown utilizing device 310b corresponding to a handheld or mobile device to view activity stream 350, however in other implementations subscribing user 302b may access activity stream 350 utilizing other computing devices, such as a computer, smart television, or other device.

According to FIG. 4, FIG. 4 shows an exemplary diagram of a more detailed user activity stream. Activity stream 450 of FIG. 4 is shown with published data 452 including passively monitored activities 1000 and uploaded activities 1100. Passively monitored activities 1000 is shown with activity 1002 and location 1004, while uploaded activities 1100 is shown with activity 1102 and status 1104. Further shown in activity stream 450 of FIG. 4 is history data 454 containing activity log 1200, date log 1300, location log 1400, and connections log 1500.

As previously discussed in reference to FIG. 3, activity stream 450 may correspond to an aggregation and publication of real and/or virtual activity data corresponding to a user. Thus, activity stream 450 includes published data 452. Published data 452 may contain the activity data corresponding to the user. While published data is shown with passively monitored activities 1000 and uploaded activities 1100 in FIG. 4, it is understood in different implementations more and different layouts and/or activity data.

In the example of FIG. 4, passively monitored activities 1000 is shown in published data 452. Passively monitored activities 1000 is shown containing activity 1002 and location 1004. As previously discussed, an aggregation server may receive real and/or virtual activity data passively, such as without user input. Thus, activity stream 450 may publish to published data 452 a passively monitored activity, such as a GPS location, weather data, photograph, music playlist, or other activity data. As shown in FIG. 4, passively monitored activities 1000 includes activity 1002 and activity 1002. For example, a device may passively monitor device sensors and transmit activity data that determines a user is running at a Blackacre State Park. Thus, passively monitored activities 1000 may publish “Blackacre State Park” to activity 1002 and “Out for a run!” to location 1004. However, in other implementations, different activity data may be used and/or published to activity stream 450.

Similar to above, activity stream 450 may receive uploaded activity data corresponding to a user. A user may wish to share pictures, music, statuses, or other content on activity stream 450. Thus, the user may upload the shared content. When received, activity stream 450 publishes the activity data in uploaded activities 1100. In FIG. 4, uploaded activities 1100 further includes activity 1102 and status 1104. For example, if the user wishes to uploaded a status stating it is the user's birthday and they are celebrating with friends, activity stream 450 may receive corresponding activity information. Thus, activity stream 450 may publish to activity 1102 of uploaded activities 1100 “Celebrating with Friends!” and may publish to status 1104 “It's my Birthday!”

Activity stream 450 also is shown containing history data 454. History data 454 is shown containing activity log 1200, date log 1300, location log 1400 and connections log 1500. In FIG. 4, history data 454 is shown as visible on activity stream 450. However, in other implementations, history stream 454 may be hidden or partially viewable depending on settings. For example, a user may wish to hide past history, or exclude past history at a date, to specific people, or of concerning certain topics. Thus, history data 454 may be obscured, only partially viewable, or contain certain permissions.

History data 454 of FIG. 4 is shown with activity log 1200, date log 1300, location log 1400, and connections log 1500. Each of activity log 1200, date log 1300, location log 1400, and connections log 1500 may contain linked data corresponding to past activity data uploaded and published to activity stream 450. Activity log 1200 may correspond to a log of past activities uploaded and published to activity stream 450. Activity log 1200 may contain real and/or virtual activities, such as statuses, events attended, games played, music choices, or other activity data. Each uploaded and published activity may further include a date and time viewable in date log 1300. Furthermore, each activity may also include a history of locations viewable in location log 1400. Finally, each activity may also include a list of connections or people associated with the activity, further viewable in connections log 1500. Each log may correspond to a separate aggregation of activity data. Thus, activity data may be easily searched, filtered, and/or archived. As previously discussed, history data 454 may be configurable to set permissions, time limits, and/or topic filters in order to partially or entirely hide activity log 1200.

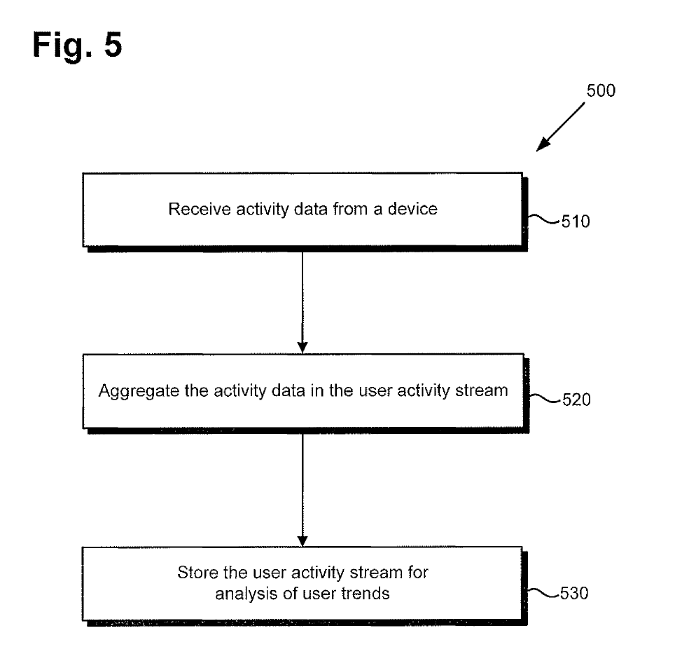

FIGS. 1, 2A, 2B, 3, and 4 will now be further described by reference to FIG. 5, which presents flowchart 500 illustrating a method for aggregation of user activity data into a user activity stream. With respect to the method outlined in FIG. 5, it is noted that certain details and features have been left out of flowchart 500 in order not to obscure the discussion of the inventive features in the present application.

Referring to FIG. 5 in combination with FIG. 1, FIG. 2A, FIG. 2B, FIG. 3, and FIG. 4, flowchart 500 begins with receiving activity data from a device 110/210/310a. The receiving may be performed by processor 222 of aggregation server 120/220 after receiving activity data corresponding to user 102 (510). Device 110/210/310a may transmit the activity data over network 130/230. Device 110/210/310a may transmit virtual activity data corresponding to user 102 from memory 214 of device 110/210/310a, such as virtual data 215. Virtual activity data may also correspond to user 102 utilizing device 110/210/310a for virtual interactions, such as messaging, playing games, listening to music, watching videos or updating social media profiles. Additionally, device 110/210/310a may transmit real activity data corresponding to user 102 from device sensors 216. For example, device 110/210/310a may utilize device sensors 216 to receive real activity data corresponding to user 102, such as user 102 visiting recreational environment 104 or attending event 106.

The method of FIG. 5 continues with aggregating the activity data in a user activity stream 350/450 (520). The aggregating may be performed by processor 222 of aggregation server 120/220 after receiving activity data corresponding to user 102 over network 130/230. Aggregation server 220 may utilize aggregation module 230 stored in memory 224 to perform the aggregation of the real and virtual activity data. Aggregation server 220 may aggregate the real and virtual activity data into activity stream 350/450. Activity stream 350/450 may then contain the real and virtual activity data.

Flowchart 500 of FIG. 5 concludes with storing the user activity stream 350/450 for analysis of user trends (530). The storing may be performed by processor 222 of aggregation server 120/220 after aggregating the activity data into activity stream 350/450. Processor 222 of aggregation server 120/220 may store the activity stream 350/450 in activity stream database 240 of memory 224. Processor 222 may further utilize analysis module 232, linking module 234, and customization module 236 with activity stream 350/450. Further, aggregation server 120/220 may publish activity stream 350/450 for viewing by subscribing user 302b using device 310b.

Utilizing the above, an activity stream containing real and virtual user activities may be aggregated, created, and published. The activity stream gives a powerful analysis tool of user trends. Further, users are encouraged to utilize the activity stream as an easy and streamlined social media platform.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A method for use by a system including a processor and a memory for aggregation of user activity data into a user activity stream, the method comprising:
receiving activity data from a device;
aggregating the virtual activity data and the real activity data in the user activity stream; and
storing the user activity stream for analysis of user trends.

2. The method of claim 1 further comprising:
using the user trends to customize a digital item.

3. The method of claim 2, wherein the digital item is one of a virtual environment, an interactive game, and a social media profile.

4. The method of claim 1 further comprising:
using the user trends to determine a flow of user movement through a location.

5. The method of claim 1 further comprising:
using the user trends to deliver personalized content to a user.

6. The method of claim 1, wherein the activity data is one of real activity data and virtual activity data.

7. The method of claim 1 further comprising:
connecting the user activity stream to at least one other user profile.

8. The method of claim 1 further comprising:
publishing the user activity stream for viewing.

9. A system for aggregation of user activity data into a user activity stream, the system comprising:
an aggregation server accessible over a communication network, the aggregation server including a processor and a memory;
an aggregation module stored in the memory;
the aggregation module, under the control of the processor, configured to:
receive virtual activity data from a device;
receive real activity data from at least one sensor of the device;
aggregate the virtual activity data and the real activity data in the user activity stream; and
store the user activity stream for analysis of user trends.

10. The system of claim 9 further comprising a customization module, wherein the customization module is configured to:
use the user trends to customize a digital item.

11. The system of claim 10, wherein the digital item is one of a virtual environment, an interactive game, and a social media profile.

12. The system of claim 9 further comprising an analysis module, wherein the analysis module is configured to:
use the user trends to determine a flow of user movement through a location.

13. The system of claim 9, wherein the aggregation module is further configured to:
use the user trends to deliver personalized content to a user.

14. The system of claim 13, wherein the personalized content is one of advertisements, user activity options, and interactive digital content.

15. The system of claim 9, wherein the at least one sensor is a mobile device sensor.

16. The system of claim 9 further comprising a linking module, wherein the linking module is configured to:
connect the user activity stream to at least one other user profile.

17. A computing device for aggregation of virtual activity data and real activity data, the computing device comprising:
at least one sensor;
a memory including user data; and
a processor configured to:
receive the virtual activity data from the memory;
receive the real activity data from the at least one sensor;
transmit the virtual activity data and the real activity data to a server for aggregation in a user activity stream for analysis of user trends.

18. The computing device of claim 17, wherein the processor is further configured to receive a user location from a user tracking device.

19. The computing device of claim 17, wherein the processor is further configured to monitor the at least one sensor for the real activity data.

20. The computing device of claim 19, wherein monitoring is performed without user action.
